(19) United States
(12) Patent Application Publication
(10) Pub. No.: US 2013/0014615 A1
(43) Pub. Date: Jan. 17, 2013

(54) DUAL PURPOSE WATER METER TOOL

(71) Applicant: Joel G. Peterson, Gallup, NM (US)

(72) Inventor: Joel G. Peterson, Gallup, NM (US)

(21) Appl. No.: 13/354,562

(22) Filed: Jan. 20, 2012

Related U.S. Application Data
(60) Provisional application No. 61/508,144, filed on Jul. 15, 2011.

(51) Int. Cl. B25B 13/48; B25B 13/02

(52) U.S. Cl. 81/119

(57) ABSTRACT

Dual purpose water meter key configured to be utilized in the field to open both water meter covers and water meter shut off valves using one tool. The key can include both a pentagonal abscess and a parallel abscess, the former being used to manipulate a shaped nut associated with a water meter cover and open the water meter cover and the latter used to manipulate a water meter valve and thereby open or close it. A socket abscess can be located on the opposite side of the key to connect the key to receive a bar enabling a user to reach farther into locations behind a meter cover as well as a handle can be provided with the bar to enable a user to gain torque in the case of rusty systems.

### INVENTION PRIORITY

The present invention claims priority as a Continuation Application of U.S. Provisional Patent Application Ser. No. 61/508,144, filed Jul. 15, 2011, entitled “Dual Purpose Water Meter Tool”, which is herein incorporated by reference.

### FIELD OF THE INVENTION

The present invention is generally related to a utility valve key, and in particular, to a utility valve key that is also suitable for use in the unlocking and removal of water meter covers and to control water meter shut-off valves and is characterized by its simplicity, cost effectiveness and reliability.

### BACKGROUND

Several apparatuses in the field of this invention exist, however, many are single purpose suited or designed for different valve openings. This invention relates to shutoff keys which are capable of unlocking meter covers for removal, where covers are typically flush mounted on street or sidewalk surfaces, as well as operating shut off valves. It is of importance to note that while various inventions in the field of this invention exist that are practically suited for the single task of opening or closing water valves, none have been found with the dual purpose that this invention provides. This apparatus is especially useful because of its utility in unlocking water meter covers and also being used to operate (shut-off, or turn on) water meter valves once an unlocked water meter cover has been removed.

In emergency situations it would be prudent to have a dual purpose key that would enable an operator of the invention to quickly and easily gain access to a water meter by unlocking and removing the cover and then turn off the water valve, using one single tool to both unlock the cover and turn off the valve.

In situations of utility, such as a water line worker would encounter, where ease of access to multiple water valves is paramount, the tool would increase production and ease for said worker. Accessing multiple water meters and needing but a single tool would prove invaluable.

Finally, it is becoming more important today for municipalities to lock manhole covers to prevent their theft as well as injury that can result with an exposed manhole.

### SUMMARY OF THE INVENTION

The dual purpose of this invention is to provide a tool that can both unlock keyed manhole covers for removal and also shut off/turn on water valves located behind a manhole cover. This can be accomplished utilizing a main bar with a handle on one end and a dual purpose key and valve operator on the other end. The main bar can be equipped with a “T” handle on one end. Such a handle is known for enhancing the amount of torque an operator can cause at the opposite end of the tool bearing a handle. On the other end can be the water meter key with a slot as well as a pentagon shaped (or other key shaped) abscess necessary to unlock keyed water meter covers. The slot can be used for water meter shut off valves. Both are built into a head portion that can be machined at varying depths allowing the head portion to function as both a key to unlock/open water meter covers and a slot to close and open water meter shut off valves. The other side of the key can be made to attach via socket to the main bar (i.e., “T” bar) allowing the user of the invention to use more force and torque as well as allow ease of access to deep hard to reach places where a valve may be located beneath a manhole.

### BRIEF DESCRIPTION OF THE DRAWINGS

FIG. 1 illustrates a view of the main apparatus fully constructed with the handle attached to the key containing both the water meter cover key and the water meter valve key.

FIG. 2 illustrates a bottom view of the water meter key with modules contained therein also illustrated.

FIG. 3 illustrates the top side of the water meter key with component to connect with main apparatus clearly visible.

FIG. 4 illustrates the key with the side facing upwards that the opens the water meter cover and the water meter valve using a pattern keyed recess and the horizontal slit recess.

FIG. 5 illustrates in detail a key illustrating a hexagonal patterned water meter cover key and a slit water valve key machined in a head portion.

### DETAILED DESCRIPTION OF THE INVENTION

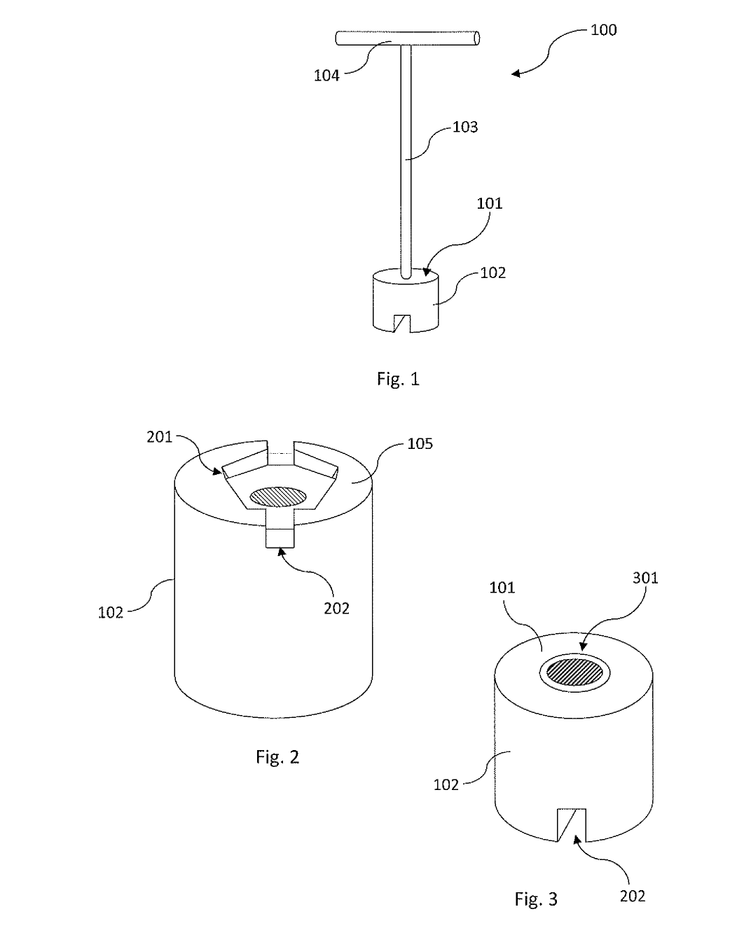

Referring to FIG. 1, illustrated is a front view of a system 100 designed to open water meter systems and operate water valves. The system 100 includes a head portion 102 at one end for receiving bar 103 that can be coupled to receiving surface 101 of the head portion 102 to allow a user to turn the head portion 102. The bar can also include a handle 104 on a second end of bar 103, opposite its interface with the receiving surface 101 of the head portion 102. Referring to FIG. 2, the head portion 102 also includes a operating surface 105 (opposite the receiving surface 101) with a key 201 and slot 202 formed (i.e., machined) therein.

The head portion 102 is presented in FIG. 2, for illustration only, having a pentagonal abscess 201 formed in the surface 105 that can be utilized to unlock water meter covers. Slot 202 is also shown to be formed in the surface 105 at a narrower width than the overall width of the key 201 and can set into the head portion 102 at the surface 105 from the top down at up to an inch deep, or so, and can be formed into the head portion slightly less deep than the key 201 is formed therein. The slot 202 is used to interface with and turn a meter valve located behind (or underneath a cover), while the key 201 of a unique shape is used to loosen/unlock a nut of the same shape located on a meter cover. The slot 202 should be provided in a width and depth that is suitable to interface with and operate a water meter valve (not shown). Both the key 201 and slot 202 can be cut or machined into the head portion 102 at the operational surface 105 of the head portion 102, but slightly lower engraved positioning of slot 202 with respect to the key 201 can allow the key to be utilized in duality as opposed to needing multiple instruments.

The present invention can be used to unlock keyed water meter covers and operate water meter valves in a simple fashion utilizing one tool instead of multiple tools as in previous inventions in the art and type of this invention. The main bar 103 can connect to the head portion 102 by a socket-like system at a bar receiver 301 shown on bar receiving surface 101, as shown in FIG. 3, or it can be welded to the head portion 102 after it is inserted in a bar receiver portion 301, without regard to socket functionality. Socket-like functionality can allow the key to be put on different sized handles, as needed, depending on the application.

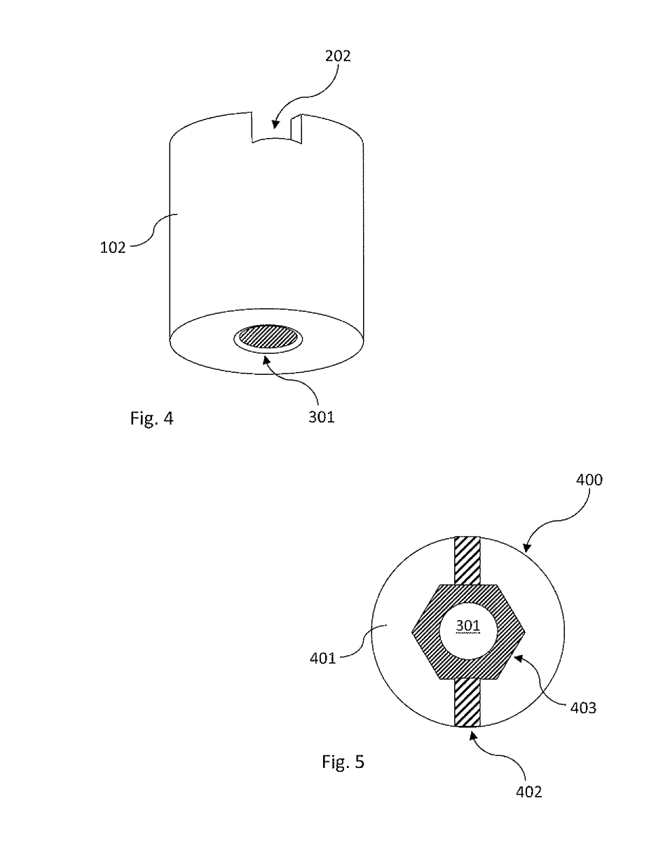

Referring to FIG. 4, illustrated is a side view bottom facing up of a head portion 102, which can be designed with a slot 202 formed therein to be utilized as a key that enables the head portion 102 to be operated to close and open a valve associated with a water meter system. Also shown is a handle receiver 301, as previously described.

Referring to FIG. 5, illustrated a top view of the operating surface 401 of a head portion 400 designed to be a water meter cover key and valve closer/opener. The view shows a hexagonal abscess 401 used to open water meter covers slightly deeper then the parallel abscess 402 used to open and close water meter valves. Also shown through the head portion 400 at its center is a bar receiver 301 which can accept a bar used to turn the head portion 400 and operate (rotate/turn) the hexagonal abscess 401 (key) on a manhole cover nut and parallel abscess 402 (valve) on a meter valve, using one tool.

What is claimed is:

1. A tool for opening water meter covers and operating shut-off valves associated therewith, comprising a head portion comprising a receiver formed in a receiving surface at a first end of the head portion, said receiver for interfacing with a bar that can be coupled to receiving surface to enable a user to turn the head portion, said head further comprising an operating surface opposite the receiving surface and including a key for unlocking water meter covers and slot formed therein for operating shut-off valves.

2. The tool for opening water meter covers and operating shut-off valves associated therewith of claim 1, wherein the key interfaces with a nut associated with a meter cover to turn and unlock the meter cover and gain access to a water meter and water valve contained behind the water meter cover, and the slot interfaces with a dial on a water meter valve contained behind the water meter cover to turn on and turn off the water meter valve.

3. The tool for opening water meter covers and operating shut-off valves associated therewith of claim 1, wherein the bar can also include a handle disposed on a second end of the bar, opposite the bar's interface with the receiving surface of the head portion.

4. The tool for opening water meter covers and operating shut-off valves associated therewith of claim 2, wherein the key interfaces with a nut associated with a meter cover to turn and unlock the meter cover and gain access to a water meter and water valve contained behind the water meter cover, and the slot interfaces with a dial on a water meter valve contained behind the water meter cover to turn on and turn off the water meter valve, wherein turning of the nut and the water meter valve is accomplished by clockwise and counterclockwise rotation of the bar coupled to the head portion.

5. The tool for opening water meter covers and operating shut-off valves associated therewith of claim 2, wherein the key interfaces with a nut associated with a meter cover to turn and unlock the meter cover and gain access to a water meter and water valve contained behind the water meter cover, and the slot interfaces with a dial on a water meter valve contained behind the water meter cover to turn on and turn off the water meter valve, wherein turning of the nut and the water meter valve is accomplished by clockwise and counterclockwise rotation of the bar coupled to the head portion and a handle associated with the bar.

6. A tool for opening water meter covers and operating shut-off valves associated therewith, comprising:
a head portion including a receiver formed in a receiving surface at a first end of the head portion, said receiver for receiving a bar that can be coupled to receiving surface to enable a user to manipulate the head portion, and an operating surface, opposite the receiving surface, including a key and slot formed therein; and
a bar including a handle disposed on a second end of the bar, opposite the bar's interface with the receiving surface of the head portion;
wherein the key interfaces with a nut associated with a meter cover to turn and unlock the meter cover and gain access to a water meter and water valve contained behind the water meter cover, and the slot interfaces with a dial on a water meter valve contained behind the water meter cover to turn on and turn off the water meter valve, wherein turning of the nut and the water meter valve is accomplished by clockwise and counterclockwise rotation of the bar coupled to the head portion.
